(19) United States
(12) Patent Application Publication
(10) Pub. No.: US 2026/0073589 A1
(43) Pub. Date: Mar. 12, 2026

(54) INFORMATION PROCESSING METHOD, INFORMATION PROCESSING SYSTEM, AND NON-TRANSITORY COMPUTER-READABLE RECORDING MEDIUM

(71) Applicant: Panasonic Intellectual Property Management Co., Ltd., Osaka (JP)

(72) Inventors: TOMOYASU YOKOYAMA, Osaka (JP); KAZUHIDE ICHIKAWA, Kyoto (JP)

(21) Appl. No.: 19/390,730

(22) Filed: Nov. 17, 2025

Related U.S. Application Data
(63) Continuation of application No. PCT/JP2024/018544, filed on May 20, 2024.

(30) Foreign Application Priority Data
Jun. 1, 2023 (JP) 2023-091028

(51) Int. Cl. G06T 11/20

(52) U.S. Cl. CPC G06T 11/26

(57) ABSTRACT

An information processing method to be executed by a computer is provided. The method includes acquiring energy information indicating a threshold of thermodynamic convex hull energy, generating a phase diagram containing one or more compounds of which the thermodynamic convex hull energy corresponds to the obtained threshold, and outputting the generated phase diagram.

### BACKGROUND

### 1. Technical Field

The present disclosure relates to a technology for displaying a phase diagram of a compound.

### 2. Description of the Related Art

Phase diagrams are the “maps” of materials discovery. By looking at a phase diagram, a user can easily understand what synthesis conditions (composition, raw materials, temperature, pressure, or the like) could be used to synthesize a target material. Even for previously unreported materials, predicting a phase diagram using first-principles calculations, a predictive model trained by machine learning, or the like can lead to the discovery of new high-functional materials.

Japanese Unexamined Patent Application Publication No. 2006-125952 discloses a surface analysis device for conducting phase analysis using a phase diagram.

### SUMMARY

One non-limiting and exemplary embodiment provides an information processing method and the like that can output a visually easy-to-understand phase diagram for a metastable compound.

In one general aspect, the techniques disclosed here feature an information processing method to be executed by a computer. The method includes acquiring energy information indicating a threshold of thermodynamic convex hull energy, generating a phase diagram containing one or more compounds of which the thermodynamic convex hull energy corresponds to the obtained threshold, and outputting the generated phase diagram. Note that this general or specific aspect may also be achieved as a device, a system, an integrated circuit, a computer program, or a computer-readable recording medium, or any selective combination of a method, a device, a system, an integrated circuit, a computer program, and a computer-readable recording medium. The computer-readable recording medium includes a non-volatile recording medium such as Compact Disc-Read-Only Memory (CD-ROM), for example.

According to the present disclosure, a visually easy-to-understand phase diagram for a metastable compound can be outputted.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is an explanatory diagram illustrating an example of a binary phase diagram according to a comparative example;

FIG. 2 is an explanatory diagram illustrating an example of a binary phase diagram displaying metastable compounds;

FIG. 3 is an explanatory diagram illustrating another example of a binary phase diagram displaying metastable compounds;

FIG. 4 is an explanatory diagram of an example of a ternary phase diagram according to a comparative example;

FIG. 5 is an explanatory diagram of an example of a ternary phase diagram displaying metastable compounds;

FIG. 6 is an explanatory diagram of another example of a ternary phase diagram displaying metastable compounds;

FIG. 7 is a block diagram illustrating an overall configuration including an information processing system according to embodiment 1;

FIG. 8 is a diagram illustrating an example of images displayed on a display in embodiment 1;

FIG. 9 is a diagram illustrating an example of a second image and a third image displayed on a display in embodiment 1;

FIG. 10 is a diagram illustrating an example of a fourth image displayed on a display in embodiment 1;

FIG. 11 is a flowchart illustrating an example of operations by an information processing system according to embodiment 1;

FIG. 12 illustrates an example of second information;

FIG. 13 is a sequence diagram illustrating an example of overall operations involving an information processing system according to embodiment 1;

FIG. 14 is a diagram illustrating an example of a first image displayed on a display in embodiment 2;

FIG. 15 is a flowchart illustrating an example of operations by an information processing system according to embodiment 2;

FIG. 16 is a diagram illustrating an example of a second image and a third image displayed on a display in embodiment 3;

FIG. 17 is a flowchart illustrating an example of operations by an information processing system according to embodiment 3;

FIG. 18 is a diagram illustrating an example of a third image displayed on a display in embodiment 4; and

FIG. 19 is a diagram illustrating another example of a third image displayed on a display in embodiment 4.

### DETAILED DESCRIPTION

### Underlying Knowledge Forming Basis of the Present Disclosure

In finding new materials, a phase diagram serves as a “map”. A phase diagram refers to a diagram in which substances (elements (atoms) or compounds) constituting a material are represented as vertices, and one or more compounds formed from these substances are represented on lines. In a phase diagram, a composition of a material and a composition representing a phase that thermodynamically coexists with the material are displayed. In a phase diagram, compositions representing phases with a thermodynamic convex hull energy of zero, or in other words, thermodynamically stable phases, are connected by straight lines.

Phase diagrams are indispensable to materials discovery because looking at a phase diagram enables a user to easily understand what synthesis conditions (composition, raw materials, temperature, pressure, or the like) could be used to synthesize a target material. Even for previously unreported materials, predicting a phase diagram using first-principles calculations, a predictive model trained by machine learning, or the like can lead to the discovery of new high-functional materials. Furthermore, recent developments in materials informatics have made it possible to search for materials over a wide range, which is expected to achieve efficient discovery of unknown materials.

Incidentally, the discovery of unknown materials entails the discovery of not only energetically stable compounds but also energetically unstable compounds. Such energetically unstable compounds are difficult to synthesize by normal thermodynamic equilibrium synthesis processes because such compounds decompose during the processes, but may be synthesized by thermodynamic non-equilibrium synthesis processes. Such energetically unstable compounds are called “metastable” compounds because, despite not being the most energetically stable, such compounds are locally stable. In the following, energetically stable compounds are also referred to simply as “stable compounds” and energetically metastable compounds are also referred to simply as “metastable compounds”.

For example, depositing a film on a substrate by epitaxial growth allows for the synthesis of a compound with a metastable crystal structure that cannot be synthesized under normal conditions. In particular, in materials discovery by materials informatics, dozens more metastable compounds than energetically stable compounds are obtained.

However, designing a metastable compound is difficult when using a conventional phase diagram. More specifically, a conventional phase diagram can only represent thermodynamic equilibrium phases, that is, stable compounds, making it difficult to design a metastable compound by looking at a conventional phase diagram. The following explains this problem using a drawing. In the following explanation, a compound indicated by a black circle in the drawing represents an energetically stable compound, while a compound indicated by a white circle in the drawing represents an energetically metastable compound.

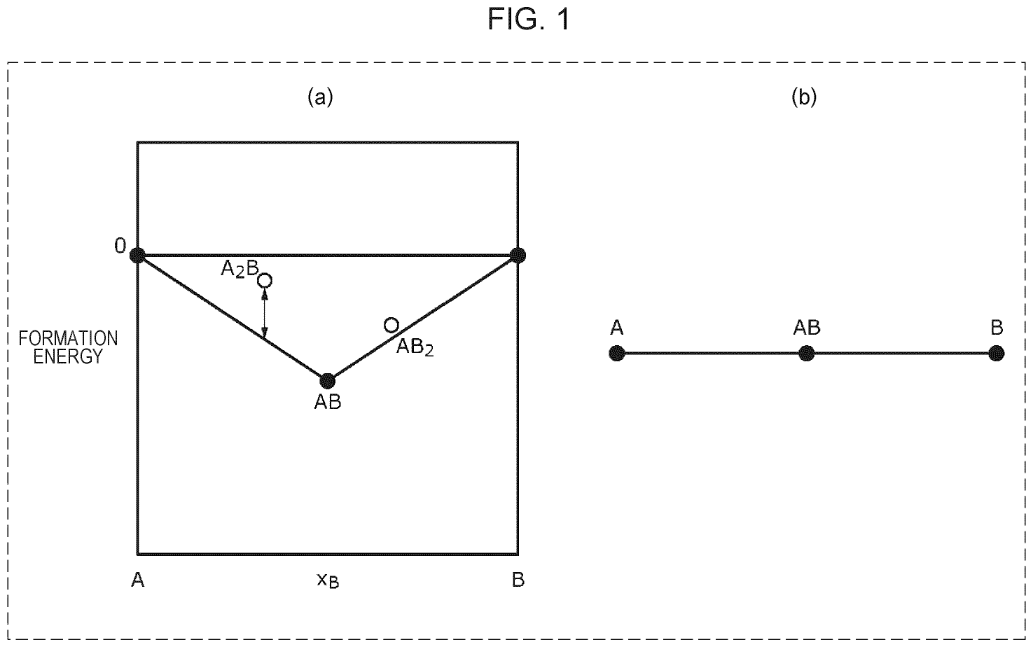

FIG. 1 is an explanatory diagram illustrating an example of a binary phase diagram (in other words, a conventional phase diagram) according to a comparative example. A binary phase diagram refers to a phase diagram for compounds formed from two elements. In the example illustrated in FIG. 1, compounds are formed from an element A and an element B.

FIG. 1(a) is a diagram indicating formation energies of compounds. In FIG. 1(a), the vertical axis represents the magnitude of the formation energy of a compound when the formation energy of each of the elements A and B is set to zero. The horizontal axis represents the composition ratio of the element B. In other words, on the horizontal axis, a composition ratio of “0” represents the element A alone, and a composition ratio of “1” represents the element B alone.

In a diagram indicating formation energies as illustrated in FIG. 1(a), the straight lines connecting elements to each other, compounds to each other, or an element to a compound represent the outline of the convex hull of these formation energies. A compound located on the outline of the convex hull is energetically stable. Consequently, in the example illustrated in FIG. 1(a), the compound AB is located on the outline of the convex hull and therefore is energetically stable, while the compounds AB₂ and the compound A₂B are not located on the outline of the convex hull and therefore are energetically metastable.

In FIG. 1(a), the distance between the outline of the convex hull and a compound (see the two-way arrow in the drawing) represents the thermodynamic convex hull energy. The thermodynamic convex hull energy is a measure of thermodynamic stability, and a value closer to zero represents a more thermodynamically stable phase. The thermodynamic convex hull energy is also a measure of the synthesizability of a crystal structure. For example, in the example illustrated in FIG. 1(a), the thermodynamic convex hull energy of the compound AB₂ is greater than 0, that is, greater than the sum of the respective formation energies of the elements A and B. For this reason, the compound AB₂ is a metastable compound that will decompose into the elements A and B during normal thermodynamic equilibrium synthesis processes.

FIG. 1(b) is a binary phase diagram of compounds. As illustrated in FIG. 1(b), in the binary phase diagram of the comparative example, information about the formation energy of an element or a compound and information about the thermodynamic convex hull energy are lost. For this reason, in the binary phase diagram of the comparative example, the energetically stable compound AB is displayed, but the metastable compounds AB₂ and A₂B are not displayed. In this way, the phase diagram in the comparative example makes it difficult for humans to visually understand metastable compounds, and is a limitation on the design and development of metastable compounds.

To address the above issue, an information processing method according to a first aspect of the present disclosure is executed by a computer and includes acquiring energy information indicating a threshold of thermodynamic convex hull energy generating a phase diagram containing one or more compounds of which the thermodynamic convex hull energy corresponds to the obtained threshold and outputting the generated phase diagram.

With this arrangement, a visually easy-to-understand phase diagram for a metastable compound can be outputted.

As another example, in an information processing method according to a second aspect of the present disclosure, the first aspect may be configured such that, in the generating of the phase diagram, if the energy information is updated to another threshold of thermodynamic convex hull energy, the phase diagram is updated on the basis of the updated energy information, and in the outputting of the phase diagram, the updated phase diagram is outputted.

With this arrangement, a visually easy-to-understand phase diagram for a metastable compound can be outputted.

As another example, an information processing system according to a third aspect of the present disclosure is provided with a display controller that, after a first image for accepting input of first information pertaining to elements is displayed on a display, causes the display to display a second image representing material property information indicating a material property of compounds containing the elements and a third image representing a phase diagram containing one or more compounds corresponding to the material property information from among the compounds.

With this arrangement, a visually easy-to-understand phase diagram for a metastable compound can be outputted.

As another example, in an information processing system according to a fourth aspect of the present disclosure, the third aspect may be configured such that the second image includes a bar indicating an upper limit of the material property at a first end thereof and a lower limit of the material property at a second end thereof, and a pointer that can be moved between the first and second ends of the bar, and input of the material property information is accepted according to the position of the pointer along the bar.

With this arrangement, a visually easy-to-understand phase diagram for a metastable compound can be outputted.

As another example, in an information processing system according to a fifth aspect of the present disclosure, the third or fourth aspect may be configured such that the material property information indicates a threshold of thermodynamic convex hull energy.

With this arrangement, a visually easy-to-understand phase diagram for a metastable compound can be outputted.

As another example, in an information processing system according to a sixth aspect of the present disclosure, the fifth aspect may be configured such that the phase diagram includes two or more thermodynamically stable compounds and two or more thermodynamically metastable compounds that correspond to the threshold of thermodynamic convex hull energy, in the phase diagram, each of the two or more thermodynamically stable compounds is connected and represented by first lines connecting the compounds, and in the phase diagram, each of the two or more thermodynamically metastable compounds is connected and represented by second lines of a different line type than the first lines.

With this arrangement, a visually easy-to-understand phase diagram for a metastable compound can be outputted.

As another example, in an information processing system according to a seventh aspect of the present disclosure, any one of the third to sixth aspects may be configured such that the display controller, upon accepting selection of a designated compound represented in the phase diagram in the third image, causes the display to display a fourth image indicating compound information pertaining to a material property of the designated compound.

With this arrangement, a visually easy-to-understand phase diagram for a metastable compound can be outputted.

As another example, in an information processing system according to an eighth aspect of the present disclosure, any one of the third to seventh aspects may be configured such that the display controller causes the display to display the third image representing the phase diagram containing an unknown compound predicted by a predictive system.

With this arrangement, a visually easy-to-understand phase diagram for material properties of a metastable compound can be outputted.

As another example, in an information processing system according to a ninth aspect of the present disclosure, the eighth aspect may be configured such that the display controller, upon accepting selection of the unknown compound represented in the phase diagram in the third image, causes the display to display a fourth image indicating compound information pertaining to a material property of the unknown compound predicted by the predictive system.

With this arrangement, a visually easy-to-understand phase diagram for a metastable compound, including an unknown compound, can be outputted.

As another example, in an information processing system according to a 10th aspect of the present disclosure, any one of the third to ninth aspects may be configured such that the display controller causes the display to display the third image representing the phase diagram generated on the additional basis of a temperature condition and/or a pressure condition on the compounds.

With this arrangement, a visually easy-to-understand phase diagram for a metastable compound, taking into account temperature and/or pressure, can be outputted.

As another example, in an information processing system according to an 11th aspect of the present disclosure, any one of the third to 10th aspects may be configured such that the display controller causes the display to display the third image representing the phase diagram additionally having an energy axis indicating a formation energy of each of the compounds.

With this arrangement, a visually easy-to-understand phase diagram for the stability of a metastable compound can be outputted.

A program according to a 12th aspect of the present disclosure causes a computer to execute a process that includes acquiring energy information indicating a threshold of thermodynamic convex hull energy, generating a phase diagram containing one or more compounds of which the thermodynamic convex hull energy corresponds to the obtained threshold, and outputting the generated phase diagram.

With this arrangement, a visually easy-to-understand phase diagram for a metastable compound can be outputted.

The characteristic processing included in an information processing method of the present disclosure can also be implemented as a computer program to be executed by a computer. In addition, a computer program like the above obviously may be distributed on a non-transitory computer-readable recording medium such as CD-ROM, or over a communication network such as the Internet.

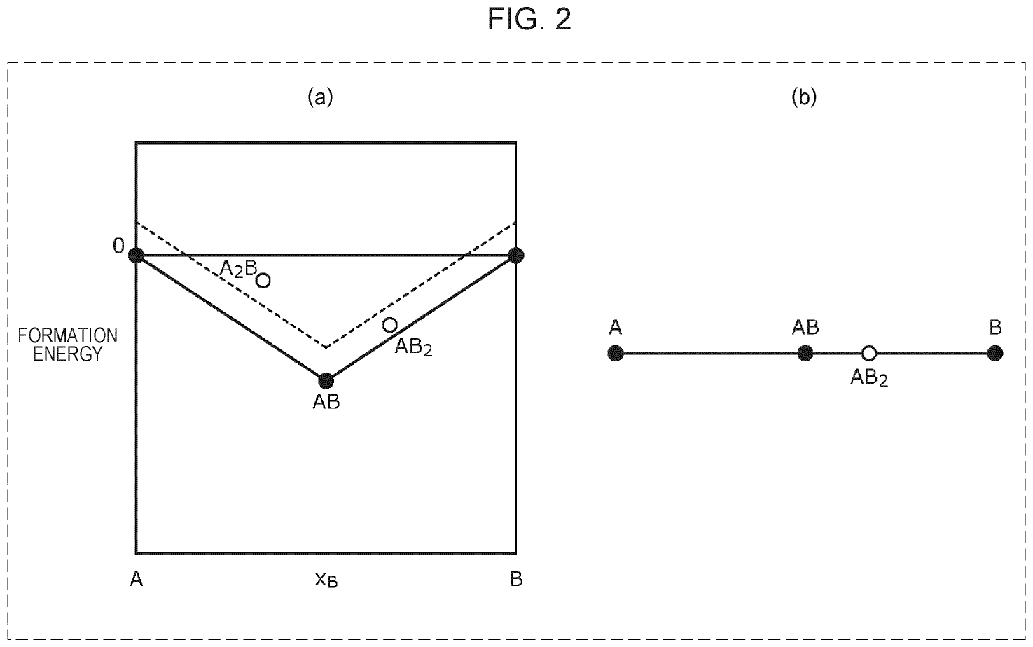

In other words, according to the technology of the present disclosure, a binary phase diagram can be outputted in which a metastable compound having a thermodynamic convex hull energy greater than zero and less than or equal to a threshold (or less than the threshold) is displayed on the outline (straight line) of the convex hull. FIG. 2 is an explanatory diagram illustrating example of a binary phase diagrams displaying metastable compounds. In the example illustrated in FIG. 2, like the example illustrated in FIG. 1, compounds are formed from an element A and an element B.

FIG. 2(a) is a diagram indicating formation energies of compounds, and FIG. 2(b) is a binary phase diagram of the compounds. In FIG. 2(a), the vertical axis represents the magnitude of the formation energy of a compound when the formation energy of each of the elements A and B is set to zero, and the horizontal axis represents the composition ratio of the element B. Also, in FIG. 2(a), the dashed line represents a threshold of thermodynamic convex hull energy. In other words, a metastable compound with a formation energy lower than the dashed line is displayed on the binary phase diagram.

In the example illustrated in FIG. 2(a), the metastable compound AB₂ has a thermodynamic convex hull energy greater than zero and less than the threshold. For this reason, as illustrated in FIG. 2(b), not only the stable compound AB but also the metastable compound AB₂ are displayed on the outline (straight line) of the convex hull in the binary phase diagram.

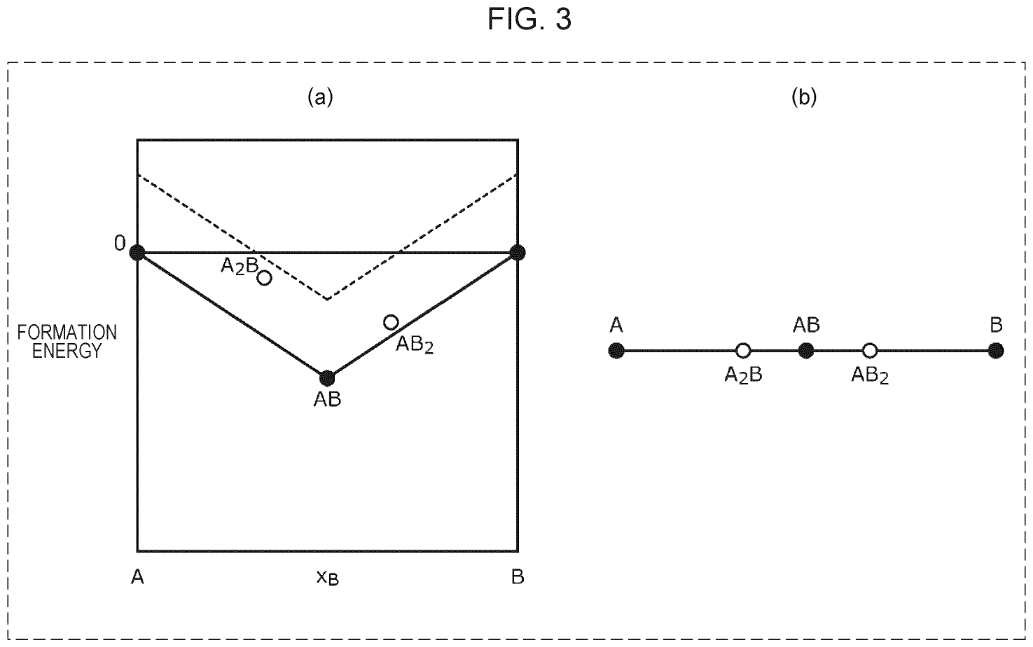

FIG. 3 is an explanatory diagram illustrating another example of a binary phase diagram displaying metastable compounds. The example illustrated in FIG. 3 differs from the example illustrated in FIG. 2 in that the threshold of thermodynamic convex hull energy is set to a greater value than in the example illustrated in FIG. 2. In the following description of the example illustrated in FIG. 3, portions in common with the example illustrated in FIG. 2 are omitted from the description.

In the example illustrated in FIG. 3(a), unlike the example illustrated in FIG. 2(a), not only the metastable compound AB₂ but also the metastable compound A₂B have thermodynamic convex hull energies greater than zero and less than the threshold. For this reason, as illustrated in FIG. 3(b), and unlike the example illustrated in FIG. 2(b), the metastable compound A₂B is additionally displayed on the outline (straight line) of the convex hull in the binary phase diagram. In this way, when the threshold of thermodynamic convex hull energy changes, the metastable compounds displayed in the phase diagram also change.

According to the technology of the present disclosure, a multicomponent phase diagram displaying metastable compounds can also be outputted. A multicomponent phase diagram refers to a phase diagram for compounds formed from multiple (herein, three or more) elements. The following describes a ternary phase diagram displaying metastable compounds as an example of a multicomponent phase diagram displaying metastable compounds.

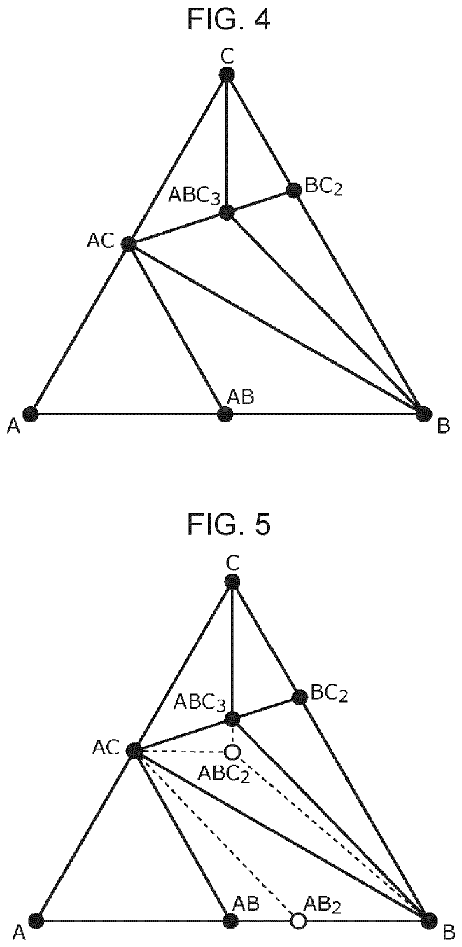

FIG. 4 is an explanatory diagram of an example of a ternary phase diagram according to a comparative example. FIG. 5 is an explanatory diagram of an example of a ternary phase diagram displaying metastable compounds. In the examples illustrated in FIGS. 4 and 5, compounds are formed from an element A, an element B, and an element C. As illustrated in FIG. 4, in the ternary phase diagram of the comparative example, an energetically stable compound ABC₃ is displayed, but metastable compounds ABC₂ and AB₂ are not displayed. In contrast, according to the technology of the present disclosure, as illustrated in FIG. 5, by appropriately setting the threshold of thermodynamic convex hull energy, not only the stable compound ABC₃ but also the metastable compounds ABC₂ and AB₂ are displayed in the ternary phase diagram.

Furthermore, according to the technology of the present disclosure, as indicated by the dashed lines in FIG. 5, the user can look at the ternary phase diagram to easily understand which compounds a metastable compound changes into after decomposition. The example illustrated in FIG. 5 suggests that the metastable compound ABC₂ decomposes into three substances, namely the compound ABC₃, a compound AC, and the element B, which are connected by dashed lines. Conversely, the user can look at the ternary phase diagram to easily understand that the compound ABC₂ possibly could be synthesized by thermodynamic non-equilibrium synthesis processes using these three substances. In this way, a ternary phase diagram displaying metastable compounds not only enables the user to evaluate the stability of metastable compounds, but also makes it easier for the user to understand the synthesis conditions or decomposition reactions of metastable compounds, thus facilitating the creation of new materials.

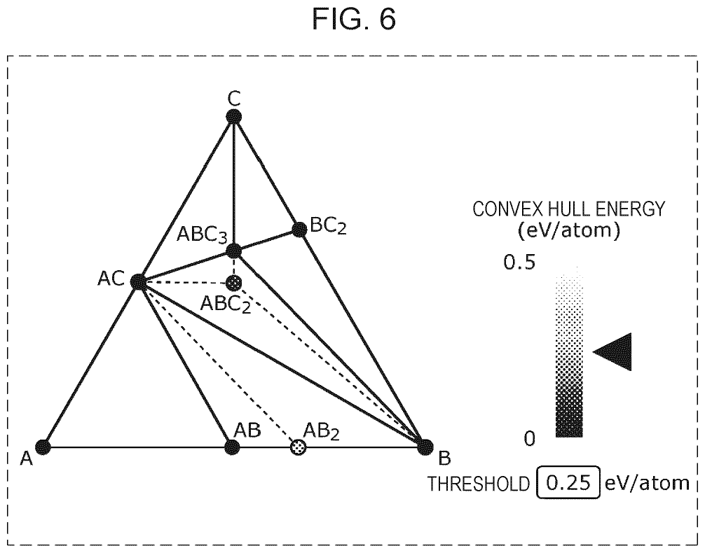

Furthermore, according to the technology of the present disclosure, as illustrated in FIG. 6, the user can freely set the threshold of thermodynamic convex hull energy. FIG. 6 is an explanatory diagram of another example of a ternary phase diagram displaying metastable compounds. In the example illustrated in FIG. 6, the user can set the threshold of thermodynamic convex hull energy by using a bar and a pointer, or by entering a value into a text box. By using the bar and the pointer, the user can dynamically change the threshold of thermodynamic convex hull energy, and thus more easily understand the relationship between the thermodynamic convex hull energy and the stability of metastable compounds. By entering a value into the text box, the user can set the threshold of thermodynamic convex hull energy, and thus more easily understand the metastable compounds at the threshold of thermodynamic convex hull energy designated by the user.

Hereinafter, embodiments will be described specifically with reference to the drawings.

Note that the embodiments described hereinafter all illustrate general or specific examples of the present disclosure. Features such as numerical values, shapes, materials, components, layout positions and connection states of components, steps, and the ordering of steps indicated in the following embodiments are merely examples, and are not intended to limit the present disclosure. In addition, among the components in the following embodiments, components that are not described in the independent claim indicating the broadest concept are described as optional components. Also, each diagram is a schematic diagram, and does not necessarily illustrate a strict representation. Also, in each diagram, like component members are denoted with like reference signs.

Also, an information processing system according to each embodiment of the present disclosure may be configured such that all components are included in a single computer, or may be configured as a system in which components are distributed across multiple computers.

### Embodiment 1

Hereinafter, an information processing system (information processing method, or program) according to embodiment 1 of the present disclosure will be described in detail using the drawings.

### Information Processing System

First, the configuration of an information processing system used in embodiment 1 will be described.

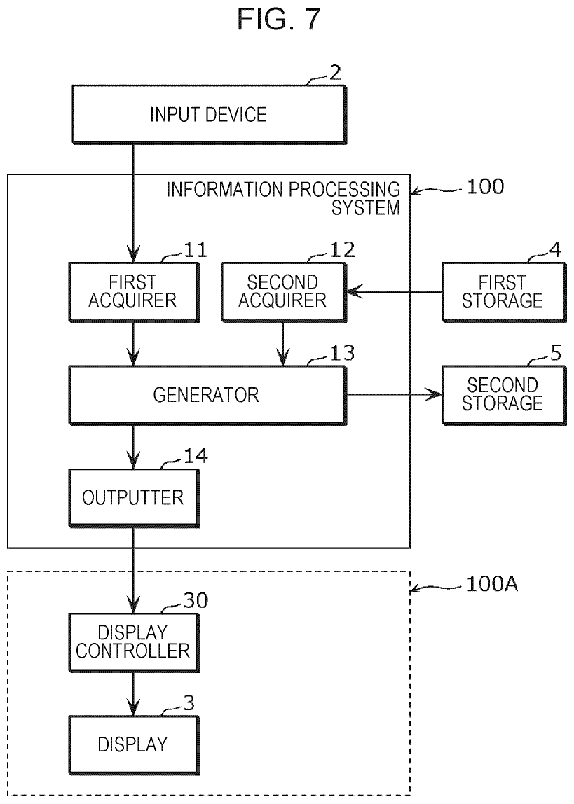

FIG. 7 is a block diagram illustrating an overall configuration including an information processing system 100 according to embodiment 1. The information processing system 100 is configured as a computer, such as a personal computer or a server, for example. In other words, the information processing system 100 may be achieved by cloud computing, for example. In embodiment 1, the information processing system 100 is described as being a stationary computer.

The information processing system 100 is provided with a first acquirer 11, a second acquirer 12, a generator 13, and an outputter 14. An input device 2, a display controller 30, a display 3, first storage 4, and second storage 5 are connected to the information processing system 100. The input device 2, the display controller 30, and the display 3 are configured as an information terminal, such as a smartphone, a tablet, or a personal computer, for example, to be used by a user.

The input device 2, the display controller 30, the first storage 4, and the second storage 5 may all be connected to the information processing system 100 by a local area network (LAN) or the like, but may also be connected to the information processing system 100 over a network such as the Internet, for example.

The input device 2 is an input interface for accepting user input, and is configured as a keyboard, a touch sensor, a touchpad, or a mouse, for example. The input device 2 accepts an input operation from the user and outputs to the information processing system 100 an input signal according to the input operation. Note that in the present disclosure, the display 3 and the input device 2 are configured independently of each other, but may also be configured in a unified way, such as in a touch panel. Also, in the present disclosure, the information processing system 100 is not provided with the display 3 or the input device 2, but may also be provided with the display 3 and the input device 2.

The input device 2 can accept input of first information pertaining to elements desired by the user. The first information is element information indicating elements, for example. Instead of element information, the first information may also be composition information indicating a composition of a target compound, composition ratio information indicating a composition ratio of elements in a target compound, crystal structure information indicating a crystal structure of a target compound, or the like. The target compound may be a compound desired by the user, for example, but may also simply be a compound to be outputted. In embodiment 1, the first information is element information.

The display controller 30 causes the display 3 to display an image and the like on the basis of information outputted from the outputter 14 of the information processing system 100.

The display 3 displays an image and the like under control by the display controller 30. The display 3 may be, but is not limited to, a liquid crystal display, a plasma display, or an organic light-emitting diode (OLED) display, for example.

The first storage 4 is a recording medium for storing a phase diagram database. The recording medium is a hard disk drive, random access memory (RAM), read-only memory (ROM), or semiconductor memory, for example. Note that such a recording medium may be volatile or non-volatile.

The phase diagram database contains compound data pertaining to compounds. Examples of compound data recorded in the phase diagram database include thermodynamic data about single elements (for example, cesium (Cs), silver (Ag), bismuth (Bi), or chlorine (Cl)) and thermodynamic data about compounds (for example, CsCl, AgCl, BiCl₃, or Cs₂AgBiCl₆). Thermodynamic data is the free energy or the like of an element or a compound at any given temperature and pressure. The thermodynamic data recorded in the phase diagram database may contain experimentally observed data or data predicted through simulation such as first-principles calculations, for example. The compound data may also contain material property information indicating material properties of a compound, such as structure information, energy information, the band gap, the volume, the ion conductivity, or the permittivity. The structure information may include the composition, the crystal system, the space group, the lattice constant, or the atomic coordinates of a compound, for example. The energy information may include the thermodynamic convex hull energy or the formation energy, for example.

The second storage 5 is a recording medium for storing fourth information indicating phase diagram data that has been generated by the generator 13 and selected by the user. The recording medium is a hard disk drive, random access memory (RAM), read-only memory (ROM), or semiconductor memory, for example. Note that such a recording medium may be volatile or non-volatile.

The first acquirer 11 acquires first information pertaining to elements such as an element A, an element B, and an element C, for example. Specifically, the first acquirer 11 acquires first information entered by the user via the input device 2. As described later, the user performs operations for entering the first information while looking at a first image which is displayed on the display 3 and which is for accepting input of the first information.

The second acquirer 12 acquires, from the first storage 4, second information pertaining to the compositions of compounds containing the entered elements. Specifically, the second acquirer 12 uses the first information entered by the user via the input device 2 as a basis for reading out, from the first storage 4, data pertaining to the compositions of compounds containing the elements indicated by the first information, and acquires the read data as second information. The data pertaining to the compositions of compounds may include data pertaining to elements and data pertaining to compounds formed by combining two or more of the elements, for example.

The generator 13 generates third information indicating a phase diagram on the basis of the first information acquired by the first acquirer 11, the second information acquired by the second acquirer 12, and energy information. The energy information indicates a threshold of thermodynamic convex hull energy. The phase diagram includes one or more compounds of which the thermodynamic convex hull energy corresponds to the acquired threshold from among compounds that each contain the elements, with each type of substance (element or compound) being represented as a vertex. Note that the energy information may be stored in advance in the information processing system 100 or obtained by referencing an external database, and may also be updated on the basis of user input as described later. Details about the processing executed by the generator 13 will be described later.

The outputter 14 outputs an image or the like to the display controller 30, thereby the image to be displayed on the display 3. The outputter 14 also outputs the third information generated by the generator 13. Specifically, the outputter 14 outputs the third information by generating a third image representing the third information generated by the generator 13 and causing the generated third image to be displayed on the display 3. As described later, the user performs an operation for selecting fourth information to be saved in the second storage 5 while looking at the third image displayed on the display 3.

### Example of Use

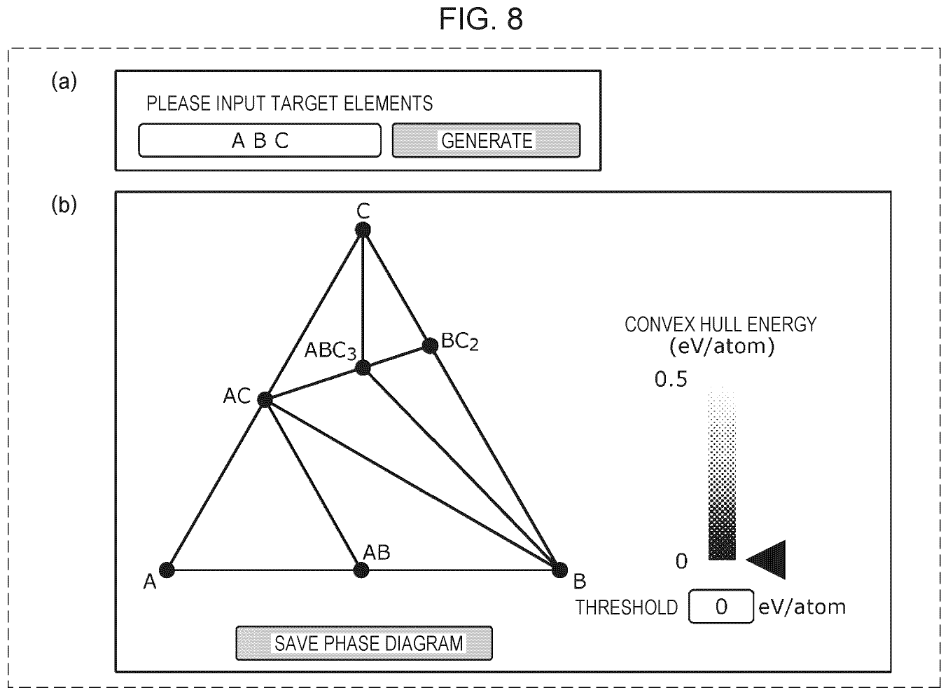

The following describes an example of use of the information processing system 100 according to embodiment 1. FIG. 8 is a diagram illustrating images displayed on the display 3 in embodiment 1. FIG. 8(a) represents an example of the first image displayed on the display 3. The first image is an image for accepting input of the first information. In embodiment 1, the first image includes a first information input area for entering the first information and an execution icon labeled “Generate”.

In the first information input area, a text box for designating user-desired elements (“target elements” in FIG. 8(a)) is displayed. The user enters the target elements into the text box and then selects the execution icon. This causes the first acquirer 11 to acquire element information as the first information. In this case, the second acquirer 12 acquires data pertaining to compounds containing the target elements entered by the user, this data being acquired from the first storage 4 as the second information. For example, if the target elements entered by the user are Cs, lead (Pb), and iodine (I), the second information is data pertaining to compounds (such as CsPbI₃, for example) containing Cs, Pb, and I. The generator 13 then generates the third information indicating a phase diagram on the basis of the first information, the second information, and the energy information. In embodiment 1, at the stage of entering the first information, the threshold of thermodynamic convex hull energy indicated by the energy information is assumed to be zero.

FIG. 8(b) represents an example of the second and third images displayed on the display 3. The second and third images are displayed on the display 3 after the user selects the execution icon in the first image and the generator 13 generates the third information. In FIG. 8(b), a phase diagram generated by the generator 13 and an execution icon labeled “Save phase diagram” correspond to the third image, and an energy input area for entering the energy information corresponds to the second image. In other words, the second image is an image (herein, an energy input area) for accepting input of material property information indicating a material property of the compounds that each contain the elements. In embodiment 1, the material property information indicates a threshold of thermodynamic convex hull energy.

The second image (energy input area) includes a bar indicating an upper limit of the material property (herein, the upper limit of the threshold of thermodynamic convex hull energy) at a first end (top end) thereof and a lower limit of the material property (herein, the lower limit of the threshold of thermodynamic convex hull energy) at a second end (bottom end) thereof, a pointer (arrow) that can be moved between the first and second ends of the bar, and a text box for designating the value of the material property. The user can input a value for the material property by sliding the pointer or by entering a material property value into the text box. In other words, in the second image, input of the material property information (herein, a threshold of thermodynamic convex hull energy) is accepted according to the position of the pointer along the bar.

When the material property information (herein, energy information) is updated, the generator 13 updates the phase diagram on the basis of the updated energy information. The display controller 30 then causes the display 3 to display the third image representing the updated phase diagram.

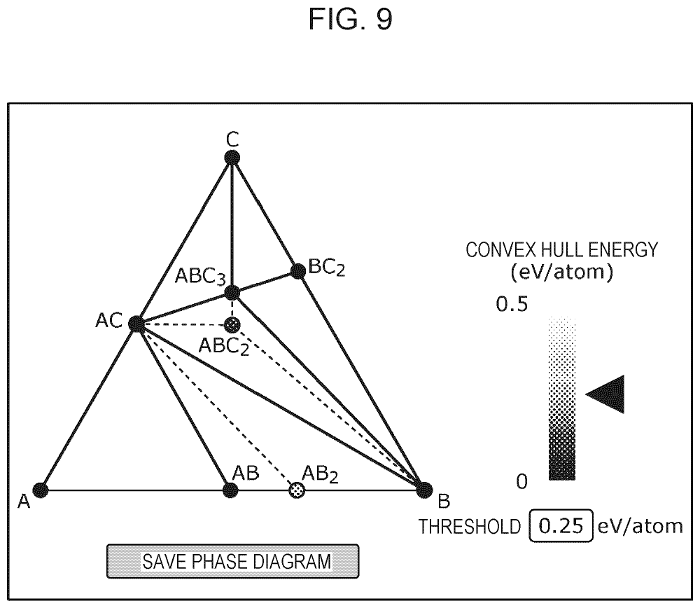

FIG. 9 is a diagram illustrating an example of the second image and the third image displayed on the display 3 in embodiment 1. The third image illustrated in FIG. 9 represents a phase diagram containing one or more compounds of which the thermodynamic convex hull energy is 0.25 eV/atom or less. In the phase diagram illustrated in FIG. 9, compounds connected by solid lines (first lines) represent stable compounds. In the phase diagram illustrated in FIG. 9, compounds connected by dashed lines (second lines) represent compounds of which the thermodynamic convex hull energy is at or below the threshold, or in other words, metastable compounds. Note that the first lines and the second lines are not limited to solid lines and dashed lines, respectively, and may be other line types. In other words, the first lines and the second lines may be represented by mutually different line types.

The user selects the “Save phase diagram” execution icon in the third image illustrated in FIG. 8(b) or in the third image illustrated in FIG. 9. This causes fourth information indicating the phase diagram selected by the user to be saved in the second storage 5. Note that the fourth information may be saved in the second storage 5 as image data of the phase diagram, but may also be saved in the second storage 5 as table data listing the information contained in the phase diagram.

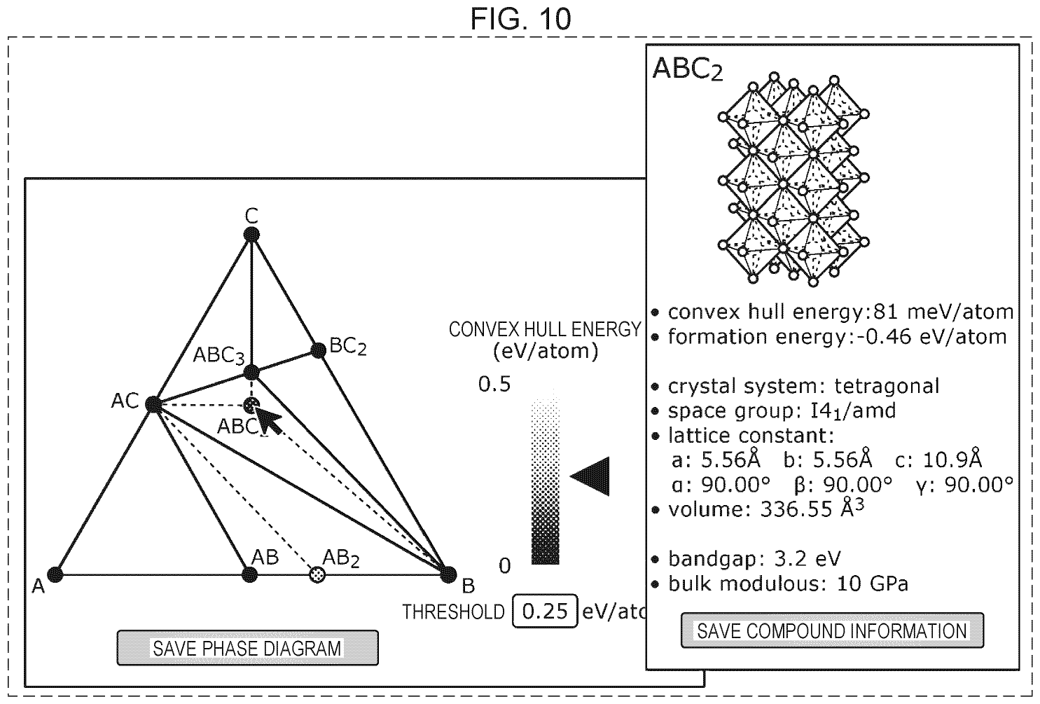

FIG. 10 is a diagram illustrating an example of a fourth image displayed on the display 3 in embodiment 1. The fourth image is displayed on the display 3 when, for example, the user selects any compound in the third image. Note that the fourth image may be displayed alone on the display 3. The fourth image includes compound information pertaining to the compound selected by the user and an execution icon labeled “Save compound information”. The compound information displayed as the fourth image may be, for example, material property information indicating material properties of the compound, such as structure information, energy information, the band gap, the volume, the ion conductivity, or the permittivity. The structure information may include the composition, the crystal system, the space group, the lattice constant, or the atomic coordinates of a compound, for example. The energy information may include the thermodynamic convex hull energy or the formation energy, for example. If the user selects the “Save compound information” execution icon in the fourth image, the compound information pertaining to the selected compound is saved in the second storage 5, in association with the fourth information indicating the phase diagram selected by the user.

### Operations

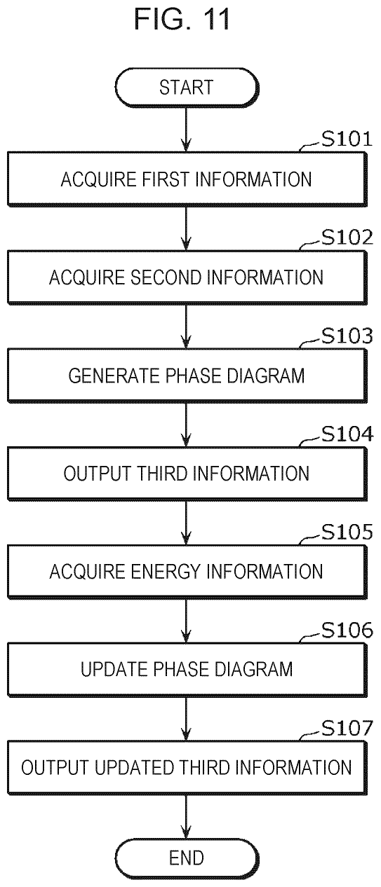

The following describes operations (in other words, an information processing method) performed by the information processing system 100 according to embodiment 1. FIG. 11 is a flowchart illustrating an example of operations by the information processing system 100 according to embodiment 1. Note that the following description assumes that the energy information is a threshold of thermodynamic convex hull energy and that the threshold is zero until the energy information is acquired in step S105, or in other words, until the energy information is updated.

### Step S101

The first acquirer 11 acquires the first information. As already described, the first information may be element information (for example, element A, element B, and element C) or the like. As already described, the first information is acquired by the first acquirer 11 in response to the user using the input device 2 to provide input (a selection) while looking at the first image displayed on the display 3. Note that the first information may also be acquired by the first acquirer 11 in response to the user using the input device 2 to enter original data without referring to the first image.

### Step S102

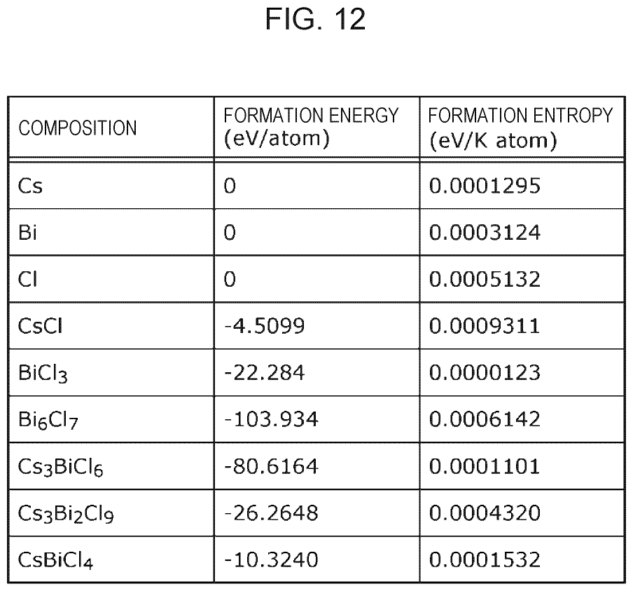

The second acquirer 12 acquires the second information. As already described, the second information pertains to the compositions of compounds containing the entered elements. The second acquirer 12 reads out, from the first storage 4, data pertaining to the compositions of compounds containing the elements indicated by the first information, and acquires the read data as second information. FIG. 12 is a diagram illustrating an example of the second information. The example illustrated in FIG. 12 represents the second information in the case where the elements are Cs, Bi, and Cl. As illustrated in FIG. 12, the second information includes compositions related to compounds and compound information about each corresponding composition. In this case, the formation energy of the corresponding composition and the formation entropy of the corresponding composition are the compound information. The compositions are the single elements (such as Cs, Bi, and Cl in this case), compounds containing the elements (such as Cs₃BiCl₆ in this case), and compounds formed by combining two or more of the elements (such as CsCl and BiCl₃ in this case).

Note that the second information may also include the total energy of the corresponding composition instead of the formation energy of the corresponding composition. In some cases, the second information may not include all possible compounds containing the elements and compounds formed by combining two or more of the elements. That is, compounds not included in the second information can be thought of as unknown compounds.

### Step S103

Returning to FIG. 11, the generator 13 executes processing for generating (acquiring) a phase diagram on the basis of the acquired first and second information and the energy information (in this case, a threshold of thermodynamic convex hull energy). For example, the generator 13 can compute the thermodynamic convex hull energies from the compositions and formation energies of the compounds included in the second information and search for compounds on the basis of a comparison between the computed thermodynamic convex hull energies and the acquired threshold, and thus generate a phase diagram containing one or more compounds of which the thermodynamic convex hull energy corresponds to the threshold (in other words, is less than or equal to the threshold). As already described, since the threshold of thermodynamic convex hull energy is zero at this point, the generator 13 generates a phase diagram containing one or more stable compounds.

For example, when the composition of the compound is CuInSe₂, the thermodynamic convex hull energy is represented by the following formula.

$$Δ {E}_{hull} ( {CuInSe}_{2} ) = max ( Δ {E}_{form} ( {CuInSe}_{2} ) - \frac{Δ {E}_{form} ( {Cu}_{2} Se )}{2} - \frac{Δ {E}_{form} ( {In}_{2} {Se}_{3} )}{2} , 0 )$$

In the formula above, “ΔEₕᵤₗₗ(A)” indicates the thermodynamic convex hull energy of compound “A”, and “ΔE_{form}(A)” indicates the formation energy of compound “A”. As indicated by the formula, when ΔEₕᵤₗₗ(A)<0, ΔEₕᵤₗₗ(A)=0 holds. The formation energy of a compound can be computed using first-principles calculations or a predictive model trained by machine learning. It has been suggested that synthesis is possible if the thermodynamic convex hull energy is 0.1 eV or less, as described for example in a research paper by Wenhao et al. (S. Wenhao et al. “The thermodynamic scale of inorganic crystalline metastability.” Science Advances 2.11 (2016): e1600225). That is, the thermodynamic convex hull energy is a measure of the synthesizability of a crystal structure. Note that “synthesis is possible” herein means that synthesis is possible by thermodynamic equilibrium synthesis processes.

### Step S104

The outputter 14 executes a process for outputting the third information indicating a phase diagram generated by the generator 13. At this point, the outputter 14 outputs the third information by causing the display 3 to display the third image representing the third information generated by the generator 13.

### Step S105

The information processing system 100 (for example, the first acquirer 11) acquires the energy information. As already described, the energy information is acquired by the information processing system 100 in response to the user using the input device 2 to provide input (a selection) while looking at the second image (energy input area) displayed on the display 3. Note that the energy information may also be acquired by the information processing system 100 in response to the user using the input device 2 to enter original data without referring to the second image. Also, the user may not enter the energy information in some cases. In such cases, steps S105 to S107 are not performed.

### Step S106

If the energy information is acquired, or in other words, if the energy information is updated, the generator 13 executes processing for updating the phase diagram on the basis of the updated energy information. For example, the generator 13 updates the phase diagram by executing processing for generating a phase diagram in a manner similar to step S103. However, in step S106, unlike step S103, the threshold of thermodynamic convex hull energy is different, and therefore the phase diagram is updated to a phase diagram that includes one or more compounds of which the thermodynamic convex hull energy corresponds to the threshold. Since the threshold of thermodynamic convex hull energy is a value greater than zero at this point, the generator 13 generates a phase diagram containing one or more metastable compounds.

### Step S107

The outputter 14 executes a process for outputting the third information indicating a phase diagram generated by the generator 13, or in other words, updated by the generator 13. At this point, the outputter 14 outputs the third information by causing the display 3 to display the third image representing the third information generated by the generator 13, or in other words, updated by the generator 13.

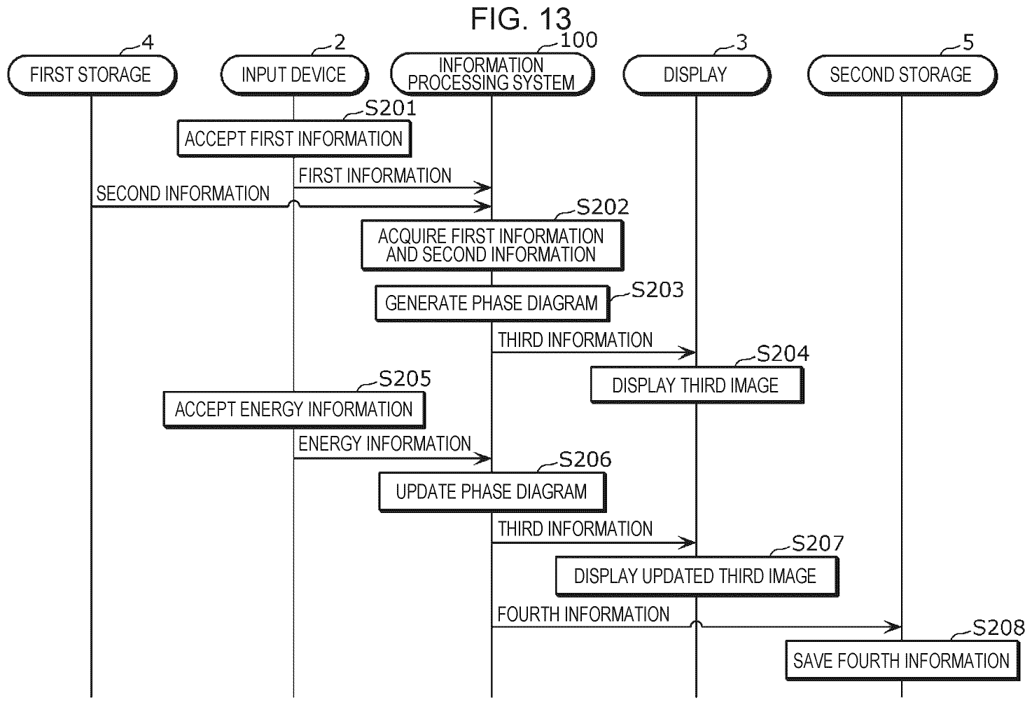

The following using a drawing to describe an example of overall operations involving the information processing system 100 according to embodiment 1. FIG. 13 is a sequence diagram illustrating an example of overall operations involving the information processing system 100 according to embodiment 1.

### Step S201

The input device 2 accepts input of the first information. At this point, the user uses the input device 2 to input (select) the first information while looking at the first image displayed on the display 3.

### Step S202

The first acquirer 11 of the information processing system 100 acquires the first information accepted by the input device 2. The second acquirer 12 of the information processing system 100 reads out, from the first storage 4, data pertaining to the compositions of compounds containing the elements indicated by the first information, and acquires the read data as second information.

### Step S203

The generator 13 of the information processing system 100 executes processing for generating (acquiring) a phase diagram including one or more compounds of which the thermodynamic convex hull energy corresponds to the threshold on the basis of the acquired first and second information and the energy information.

### Step S204

The display 3 displays the third image representing the third information outputted from the outputter 14 of the information processing system 100. The third information indicates the phase diagram generated by the generator 13. The third image is the generated third image.

### Step S205

The input device 2 accepts input of the energy information. At this point, the user uses the input device 2 to input (select) the energy information while looking at the second image displayed on the display 3.

### Step S206

The generator 13 of the information processing system 100 executes processing for generating a phase diagram including one or more compounds of which the thermodynamic convex hull energy corresponds to the updated threshold on the basis of the acquired energy information, or in other words, the updated energy information. In other words, the generator 13 executes processing for updating the phase diagram.

### Step S207

The display 3 displays the third image representing the third information indicating the phase diagram updated by the generator 13, or in other words, the updated third image, that is outputted from the outputter 14 of the information processing system 100.

### Step S208

If the user selects a phase diagram to save while looking at the updated third image displayed on the display 3, the information processing system 100 provides fourth information indicating the selected phase diagram to the second storage 5. This causes the second storage 5 to save the fourth information indicating the phase diagram selected by the user.

As described above, in embodiment 1, a phase diagram displaying a metastable compound having a thermodynamic convex hull energy greater than zero and less than or equal to a threshold (or less than the threshold) can be outputted. Consequently, in embodiment 1, since a visually easy-to-understand phase diagram for metastable compounds can be outputted, the user can more easily design and develop metastable compounds by looking at the phase diagram.

### Embodiment 2

Hereinafter, an information processing system (information processing method, or program) according to embodiment 2 of the present disclosure will be described in detail using the drawings. The information processing system according to embodiment 2 differs from the information processing system 100 according to embodiment 1 in that the information processing system according to embodiment 2 can predict compounds not included in the second information and output a phase diagram including the predicted compounds. Note that portions in common with the information processing system 100 according to embodiment 1 are omitted from the description below.

### Example of Use

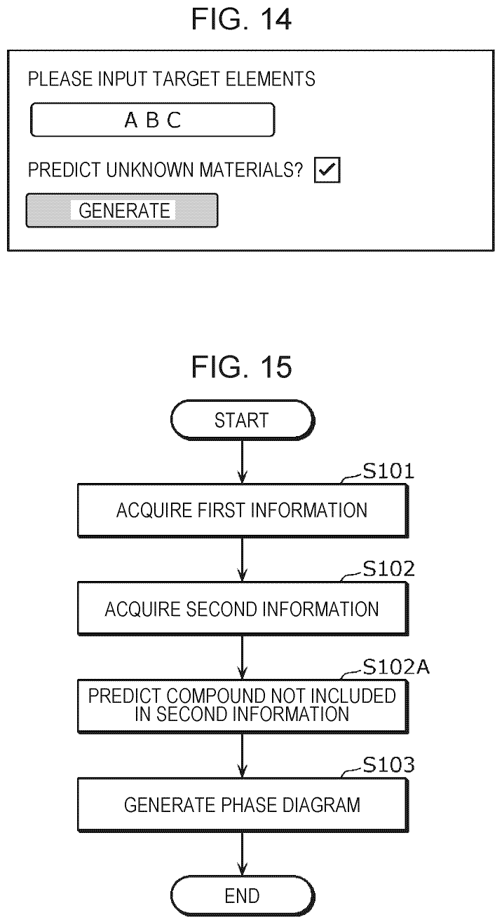

The following describes an example of use of the information processing system according to embodiment 2. FIG. 14 is a diagram illustrating an example of a first image displayed on the display 3 in embodiment 2. In embodiment 2, the first image includes a first information input area, an execution icon labeled “Generate”, and a check box for selecting whether or not to predict unknown materials.

If the user puts a check in the check box and then selects the execution icon, the generator 13 predicts compounds not included in the second information and generates a phase diagram including the predicted compounds. On the other hand, if the user selects the execution icon without putting a check in the checkbox, the generator 13 generates a phase diagram without predicting compounds not included in the second information, or in other words, generates a phase diagram according to processing similar to embodiment 1. Operations

The following describes operations (in other words, an information processing method) performed by the information processing system according to embodiment 2. FIG. 15 is a flowchart illustrating an example of operations by the information processing system according to embodiment 2. As illustrated in FIG. 15, the operations by the information processing system according to embodiment 2 differ from the operations by the information processing system 100 according to embodiment 1 in that step S102A is performed before step S103. Note that since the other steps S101 to S107 are the same as steps S101 to S107 by the information processing system 100 according to embodiment 1, a description is omitted herein. Also, step S102A is not performed if the user selects the execution icon without putting a check in the checkbox in the first image, as described above.

### Step S102A

The generator 13 executes processing for predicting compounds not included in the second information on the basis of the acquired first and second information. For example, the generator 13 predicts compounds which are formed by combining two or more of the elements and which are unknown compounds not included in the second information. The generator 13 also executes processing for generating compound information about the unknown compounds. For example, the generator 13 can predict the crystal structure on the basis of the composition of a predicted unknown compound and compute energy information about the predicted crystal structure through simulation such as first-principles calculations. The generator 13 can also compute (estimate) energy information about the predicted crystal structure by using a predictive model trained by machine learning, for example.

The predictive model is formed from a graph neural network that takes a graph structure as input. The graph neural network may be a crystal graph convolutional neural network (CGCNN) or the MatErials Graph Network (MEGNet), for example. Herein, the predictive model is formed from MEGNet. MEGNet is a graph neural network that not only uses nodes (node points; vertices) and edges (branches; sides) as features, but additionally uses global state quantities representing features of the overall system being modeled as features.

The predictive model is trained by machine learning using a large training dataset to accept input of any crystal structure and output energy information about the crystal structure. The training dataset contains crystal structures as input data and energy information corresponding to the crystal structures as ground truth data.

In step S103, the generator 13 can compute the thermodynamic convex hull energies from the compositions and formation energies of not only the compounds included in the second information but also the predicted unknown compounds and search for compounds on the basis of a comparison between the computed thermodynamic convex hull energies and the acquired threshold, and thus generate a phase diagram containing one or more compounds of which the thermodynamic convex hull energy corresponds to the threshold. In this case, the one or more compounds may include a predicted unknown compound.

As described above, in embodiment 2, predicting unknown compounds makes it possible to output a phase diagram displaying not only known compounds but also unknown compounds. Consequently, in embodiment 2, the user can more easily design and develop metastable compounds, including unknown compounds, by looking at the outputted phase diagram.

### Embodiment 3

Hereinafter, an information processing system (information processing method, or program) according to embodiment 3 of the present disclosure will be described in detail using the drawings. The information processing system according to embodiment 3 differs from the information processing system 100 according to embodiment 1 in that the outputter 14 outputs third information indicating a phase diagram that takes temperature information and pressure information into account. Note that portions in common with the information processing system 100 according to embodiment 1 are omitted from the description below.

### Example of Use

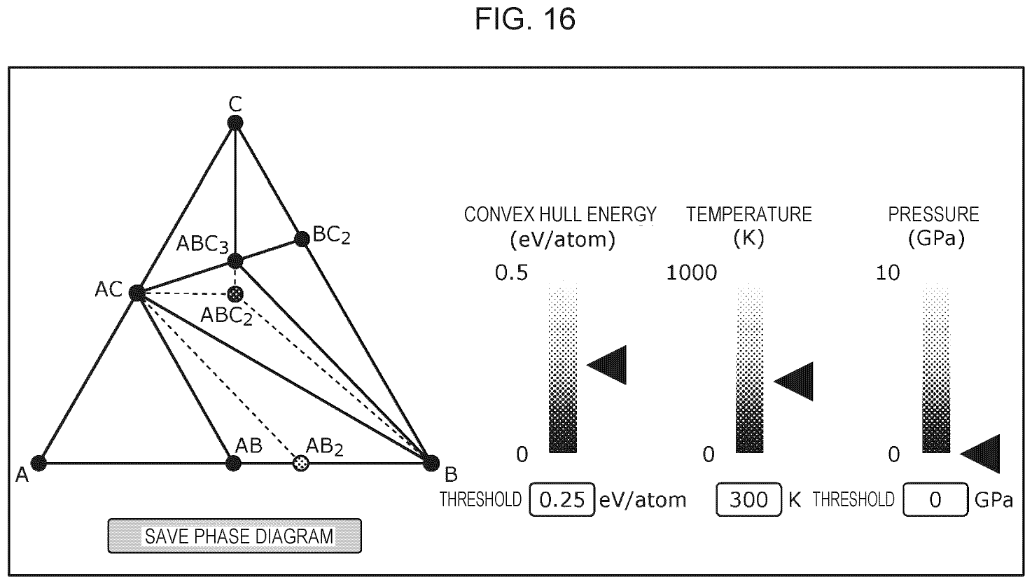

The following describes an example of use of the information processing system according to embodiment 3. FIG. 16 represents an example of the second image and the third image displayed on the display 3 in embodiment 3. The images illustrated in FIG. 16, unlike the images illustrated in FIG. 9, further include a temperature input area for entering temperature information and a pressure input area for entering pressure information.

In the temperature input area, and bar and a pointer for designating a temperature condition on compounds and a text box for designating the temperature condition are displayed. The user may designate the temperature condition using the pointer, or designate the temperature condition by entering a value into the text box.

In the pressure input area, and bar and a pointer for designating a pressure condition on compounds and a text box for designating the pressure condition are displayed. The user may designate the pressure condition using the pointer, or designate the pressure condition by entering a value into the text box.

If the user provides input designating a temperature condition in the temperature input area and/or input designating a pressure condition in the pressure input area, the generator 13 updates the phase diagram on the basis of the entered information (temperature information and/or pressure information). The outputter 14 then outputs third information indicating the phase diagram updated by the generator 13. This causes the third image indicating the updated phase diagram to be displayed on the display 3. In the example illustrated in FIG. 16, besides a target compound ABC₃, a compound ABC₂ that is thermodynamically stable in an environment at the designated temperature and pressure is displayed in the phase diagram. Also, in the phase diagram, phases that thermodynamically coexist with the compound ABC₂ are displayed using dashed lines. The user selects the “Save phase diagram” execution icon in the image. This causes fourth information indicating the phase diagram selected by the user to be saved in the second storage 5. Entering a temperature condition and a pressure condition allows for prediction of a temperature/pressure range in which, for example, the target compound can exist on the phase diagram, enabling the user to design synthesis conditions for the target compound.

### Operations

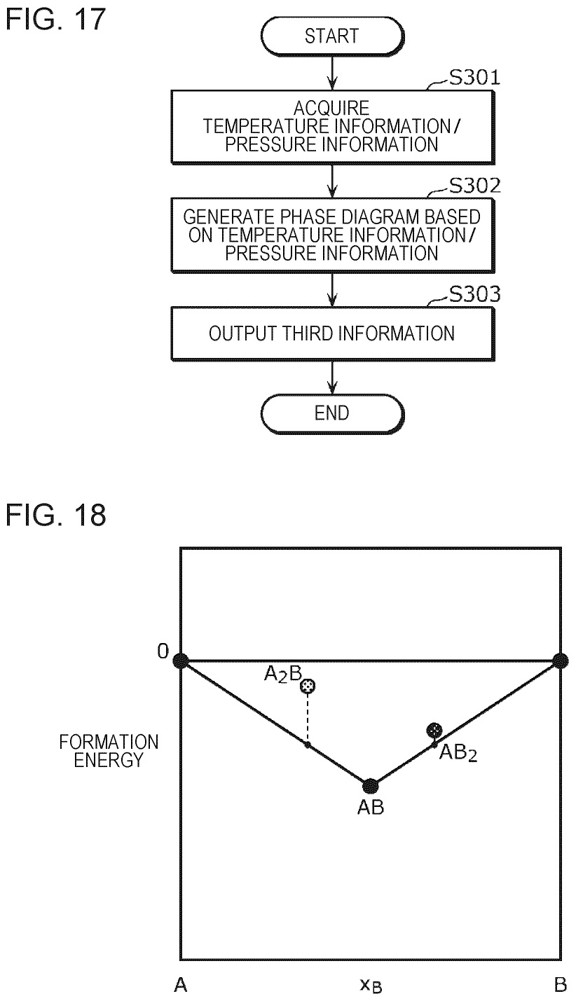

The following describes operations (in other words, an information processing method) performed by the information processing system according to embodiment 3. FIG. 17 is a flowchart illustrating an example of operations by the information processing system according to embodiment 3. The following describes processing that is performed once the user has designated a temperature and/or pressure. Since the processing before this point is the same as steps S101 to S107 by the information processing system 100 according to embodiment 1, a description is omitted herein.

### Step S301

The first acquirer 11 acquires temperature information and/or pressure information (in FIG. 17, both temperature information and pressure information are acquired). The temperature information is acquired by the first acquirer 11 in response to the user using the input device 2 to enter a temperature in the temperature input area while looking at the second and third images displayed on the display 3. The pressure information is acquired by the first acquirer 11 in response to the user using the input device 2 to enter a pressure in the pressure input area while looking at the second and third images displayed on the display 3.

### Step S302

The generator 13 executes processing for generating a phase diagram by updating the phase diagram on the basis of the acquired temperature information and/or pressure information (in FIG. 17, both temperature information and pressure information). For example, the generator 13 calculates the formation energy ΔE_{form}, taking temperature and pressure into account, on the basis of the formation energy corresponding to the composition of a compound included in the second information, the formation enthalpy change ΔH_{form}, formation entropy change ΔS_{form}, and reaction volume change ΔV_{form} included in the second information, and the acquired temperature information and/or pressure information (in this case, both temperature information and pressure information). The formation energy ΔE_{form} is represented by the following formula.

ΔE_{form}=ΔH_{form}−TΔS_{form}+PΔV_{form}

In the formula above, “T” indicates temperature and “P” indicates pressure. The generator 13 generates a phase diagram by updating the phase diagram on the basis of the computed formation energy. Note that the range of temperature is from 0 K to 2000 K, for example. The range of pressure is from 0 MPa to 1 MPa, for example. Obviously, the range of temperature is not limited to the above range. The same applies to the range of pressure.

### Step S303

The outputter 14 executes a process for outputting the third information indicating a phase diagram generated by the generator 13. At this point, the outputter 14 outputs the third information by causing the display 3 to display the third image representing the third information generated by the generator 13.

As described above, in embodiment 3, a visually easy-to-understand phase diagram for a metastable compound, taking into account temperature and/or pressure, can be outputted. Consequently, in embodiment 3, the user can more easily design and develop metastable compounds, taking into account temperature and/or pressure, by looking at the outputted phase diagram.

### Embodiment 4

Hereinafter, an information processing system (information processing method, or program) according to embodiment 4 of the present disclosure will be described in detail using the drawings. The information processing system according to embodiment 4 differs from the information processing system 100 according to embodiment 1 in that the outputter 14 outputs third information indicating a phase diagram with an added energy axis. Note that portions in common with the information processing system 100 according to embodiment 1 are omitted from the description below.

### Example of Use

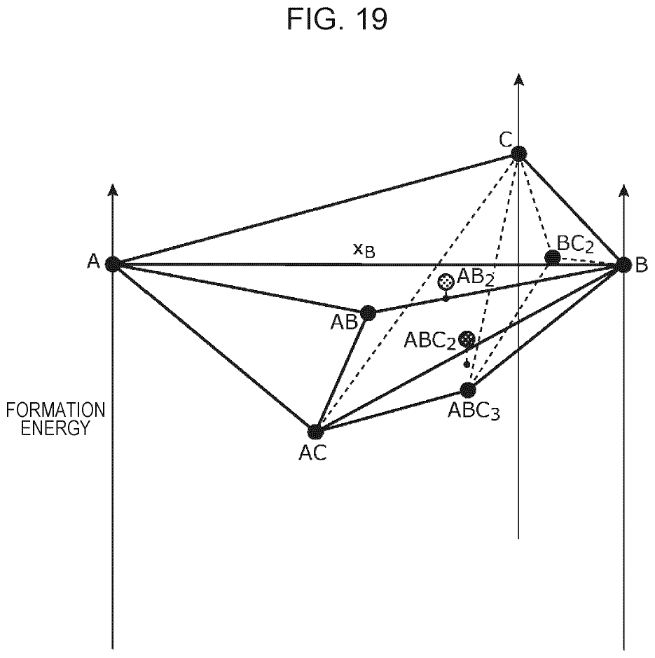

The following describes an example of use of the information processing system according to embodiment 4. FIG. 18 is a diagram illustrating an example of a third image displayed on the display 3 in embodiment 4. FIG. 19 is a diagram illustrating another example of a third image displayed on the display 3 in embodiment 4. Note that in both of the examples illustrated in FIGS. 18 and 19, the “Save phase diagram” execution icon is omitted from illustration. FIG. 18 is an example of a binary phase diagram displaying metastable compounds containing two elements (element A, element B), and FIG. 19 is an example of a ternary phase diagram displaying metastable compounds containing two or more elements from among three elements (element A, element B, element C).

As illustrated in FIGS. 18 and 19, one or more energy axes are added to both of the phase diagrams. Specifically, in FIG. 18, an energy axis passing through the element A and an energy axis passing through the element B are added, and in FIG. 19, an energy axis passing through the element A, an energy axis passing through the element B, and an energy axis passing through the element C are added. Each energy axis represents the magnitude of the formation energy. On each energy axis, the formation energy of the element A, B, or C is zero. Note that the magnitude of the energy represented by each energy axis is not limited to the magnitude of the formation energy, and may also be the magnitude of another type of energy. Also, when adding one or more energy axes to a two-dimensional plane, the phase diagram represented by a two-dimensional plane may be converted into a three-dimensional model and displayed on the display 3.

In the information processing system according to embodiment 4, the outputter 14 outputs the third information indicating the phase diagram with the further addition of information indicating the energy of each substance (element or compound) included in the phase diagram. This enables the display controller 30 to display the phase diagram with one or more added energy axes on the display 3.

As described above, in embodiment 4, a phase diagram with one or more added energy axes can be outputted. For this reason, in embodiment 4, the stability of the compounds included in the phase diagram is visually easier to understand. For example, in embodiment 1, the user is able to grasp one or more compounds included in the phase diagram, but may have difficulty grasping how stable or unstable each compound is. In contrast, in embodiment 4, the user can look at the phase diagram with one or more added energy axes to better visually grasp how stable or unstable each compound is.

### Modifications

The above describes an information processing system (information processing method) according to one or more aspects of the present disclosure on the basis of the embodiments, but the present disclosure is not limited to these embodiments. Embodiments obtained by applying various modifications that may occur to a person skilled in the art to the above embodiments may also be included in the scope of the present disclosure insofar as such embodiments do not depart from the gist of the present disclosure. Embodiments constructed by combining components from different embodiments with each other may also be included in the present disclosure.

For example, in the embodiments above, the first image, the second image, and the third image are displayed on the display 3 independently of each other, but are not limited thereto. For example, the first image, the second image, and the third image may also be displayed on the display 3 all together.

In the embodiments above, the input of energy information is performed by sliding a pointer along a bar, but is not limited thereto. For example, the input of energy information may also be performed by selecting any one material property value (for example, a threshold of thermodynamic convex hull energy) from among multiple material property values.

In the embodiments above, the first storage 4 and the second storage 5 are achieved by mutually different recording media, but are not limited thereto. For example, the first storage 4 and the second storage 5 may also be achieved by the same recording medium.

In the embodiments above, the first acquirer 11 and the second acquirer 12 are mutually different acquirers, but may also be achieved by the same acquirer.

In the embodiments above, the information processing system is formed from the first acquirer 11, the second acquirer 12, the generator 13, and the outputter 14, but is not limited thereto. For example, in the embodiments above, the information processing system may also be formed from the display controller 30 and the display 3, as indicated by “100A” in FIG. 7.

Note that in the embodiments above, each component may be formed from dedicated hardware or achieved by executing a software program suited to each component. Each component may be achieved as a result of a program executor such as a central processing unit (CPU) or a processor reading out and executing a software program recorded on a recording medium such as a hard disk or semiconductor memory.

Note that cases like the following are also included in the present disclosure.

(1) At least one device above is specifically a computer system formed from components such as a microprocessor, read-only memory (ROM), random access memory (RAM), a hard disk unit, a display unit, a keyboard, and/or a mouse. A computer program is stored in the RAM or the hard disk unit. The at least one device above achieves the functions thereof as a result of the microprocessor operating in accordance with the computer program. The computer program herein contains a combination of instruction codes that indicate commands to the computer to achieve certain functions.

(2) Some or all of the components forming the at least one device above may also be configured as a single system large-scale integration (LSI) chip. A system LSI chip is an advanced multi-function LSI chip fabricated by integrating multiple components onto a single chip, and specifically is a computer system including a microprocessor, ROM, RAM, and/or the like. A computer program is stored in the RAM. The microprocessor operates in accordance with the computer program and thereby achieves the functions of the system LSI chip.

(3) Some or all of the components forming the at least one device above may also be configured as an IC card or standalone module that can be removably inserted into the device. The IC card or module is a computer system formed from a microprocessor, ROM, RAM, and/or the like. The IC card or module may also include the advanced multi-function LSI chip above. The microprocessor operates in accordance with the computer program and thereby achieves the functions of the IC card or module. The IC card or module may also be tamper-resistant.

(4) The present disclosure may also be the methods indicated above. These methods may also be a computer program to be achieved by a computer, or a digital signal formed from the computer program.

The present disclosure may also achieved by recording the computer program or the digital signal onto a computer-readable recording medium, such as a flexible disk, hard disk, Compact Disc ROM (CD-ROM), DVD, DVD-ROM, DVD-RAM, Blu-ray® Disc (BD), and/or semiconductor memory, for example. The present disclosure may also be the digital signal recorded on these recording media.

The present disclosure may also be achieved by transmitting the computer program or digital signal over a telecommunications line, a wired or wireless communication channel, a network such as the Internet, or a data broadcast.

The present disclosure may also be carried out by another independent computer system by recording and transporting the program or digital signal on a recording medium, or by transferring the program or digital signal over a network or the like.

The present disclosure exhibits the effect of appropriately assisting a user in discovering processes for generating inorganic materials, and is usable in computer devices or systems for displaying information pertaining to such generation processes.

What is claimed is:

1. An information processing method to be executed by a computer, the information processing method comprising:
acquiring energy information indicating a threshold of thermodynamic convex hull energy;
generating a phase diagram containing one or more compounds of which the thermodynamic convex hull energy corresponds to the obtained threshold; and
outputting the generated phase diagram.

2. The information processing method according to claim 1, wherein
in the generating of the phase diagram, if the energy information is updated to another threshold of thermodynamic convex hull energy, the phase diagram is updated on the basis of the updated energy information, and
in the outputting of the phase diagram, the updated phase diagram is outputted.

3. An information processing system comprising:
a display controller that, after a first image for accepting input of first information pertaining to elements is displayed on a display, causes the display to display a second image representing material property information indicating a material property of compounds containing the elements and a third image representing a phase diagram containing one or more compounds corresponding to the material property information from among the compounds.

4. The information processing system according to claim 3, wherein
the second image includes a bar indicating an upper limit of the material property at a first end thereof and a lower limit of the material property at a second end thereof, and a pointer that can be moved between the first and second ends of the bar, and
input of the material property information is accepted according to the position of the pointer along the bar.

5. The information processing system according to claim 3, wherein the material property information indicates a threshold of thermodynamic convex hull energy.

6. The information processing system according to claim 5, wherein
the phase diagram includes two or more thermodynamically stable compounds and two or more thermodynamically metastable compounds that correspond to the threshold of thermodynamic convex hull energy,
in the phase diagram, each of the two or more thermodynamically stable compounds is connected and represented by first lines connecting the compounds, and
in the phase diagram, each of the two or more thermodynamically metastable compounds is connected and represented by second lines of a different line type than the first lines.

7. The information processing system according to claim 3, wherein the display controller, upon accepting selection of a designated compound represented in the phase diagram in the third image, causes the display to display a fourth image indicating compound information pertaining to a material property of the designated compound.

8. The information processing system according to claim 3, wherein the display controller causes the display to display the third image representing the phase diagram containing an unknown compound predicted by a predictive system.

9. The information processing system according to claim 8, wherein the display controller, upon accepting selection of the unknown compound represented in the phase diagram in the third image, causes the display to display a fourth image indicating compound information pertaining to a material property of the unknown compound predicted by the predictive system.

10. The information processing system according to claim 3, wherein the display controller causes the display to display the third image representing the phase diagram generated on the additional basis of a temperature condition and/or a pressure condition on the compounds.

11. The information processing system according to claim 3, wherein the display controller causes the display to display the third image representing the phase diagram additionally having an energy axis indicating a formation energy of each of the compounds.

12. A non-transitory computer-readable recording medium storing a program causing a computer to execute a process comprising:
acquiring energy information indicating a threshold of thermodynamic convex hull energy;
generating a phase diagram containing one or more compounds of which the thermodynamic convex hull energy corresponds to the obtained threshold;
and outputting the generated phase diagram.
